(19) United States
(12) Patent Application Publication
(10) Pub. No.: US 2018/0043942 A1
(43) Pub. Date: Feb. 15, 2018

(54) PERMANENT MAGNET PANEL FASTENER

(71) Applicant: Ronald E. Coman, Brighton, MI (US)

(72) Inventor: Ronald E. Coman, Brighton, MI (US)

(21) Appl. No.: 15/727,142

(22) Filed: Oct. 6, 2017

Related U.S. Application Data
(63) Continuation of application No. 13/896,276, filed on May 16, 2013.
(60) Provisional application No. 61/647,857, filed on May 16, 2012.

(51) Int. Cl. B62D 27/06; B60R 13/02

(52) U.S. Cl. CPC B62D 27/06; B60R 13/0206; Y10T 24/32

(57) ABSTRACT

A panel fastener and panel comprising a panel fastener that includes a support member having a magnet receiving space in which is mounted a single or multi-pole permanent magnet component presenting an exposed surface having at least one magnetic pole. The permanent magnet component may have a minimum ratio of surface area of the exposed surface to the volume of the magnet. The exposed surface of the permanent magnet component may include two or more polar surfaces of opposite magnetic domain that are located adjacent each other, and may have a polar intersection line that is at least one fourth of the length of the periphery of one of the polar surfaces.

### REFERENCE TO RELATED APPLICATIONS

This application is a continuation of copending U.S. application Ser. No. 13/896,276 filed on May 16, 2013 which claims benefit of U.S. Provisional Application No. 61/647,857 filed on May 16, 2012. The entire contents of all the aforementioned applications are incorporated herein by reference.

### TECHNICAL FIELD

This invention relates to magnetic fasteners for use in attaching automotive components to sheet metal body panels.

### BACKGROUND

Fasteners are commonly used in the automotive industry to attach decorative panels to sheet metal parts of a vehicle body. Some fasteners use a permanent magnet mounted to a surface of the decorative panel to attach the panel to the sheet metal part. In these types of fasteners, it is often desirable to use rare earth magnets because such magnets produce relatively strong magnetic fields, as compared to ferrite or alnico magnets. Rare earth magnets are made from alloys containing one or more rare earth elements, for example, neodymium magnets are made from an alloy of neodymium, iron and boron.

### SUMMARY

In accordance with one aspect of the invention there is provided a permanent magnet panel fastener that includes a support member and a multi-pole permanent magnet component. The support member has a first wall and one or more sidewalls extending away from the first wall, with each sidewall extending from a proximal end located at the first wall to a distal end spaced from the first wall. The first wall and the sidewall(s) together at least partially define a magnet receiving space of the support member having a closed end at the first wall and an open end proximate the distal end(s) of the sidewall(s). The permanent magnet component is located in the support member within the magnet receiving space. The permanent magnet component presents adjacent opposite magnetic poles at the open end of the magnet receiving space. The opposite magnetic poles correspond to first and second polar surfaces each presenting one of the opposite magnetic poles and having a periphery that is adjacent the periphery of the other polar surface along a polar intersection line. The polar intersection line has a length that is at least one fourth the total length of the periphery of the first polar surface.

In accordance with another aspect of the invention there is provided a permanent magnet panel fastener that includes a support member and a multi-pole permanent magnet component attached to a magnet mounting surface of the support member. A first side of the permanent magnet component faces towards the magnet mounting surface and a second, opposite side of the permanent magnet faces away from the magnet mounting surface. The permanent magnet component has first and second surfaces on opposite sides of the permanent magnet component and presents adjacent opposite magnetic poles at the second surface, wherein the adjacent opposite poles at the second surface correspond to first and second polar surfaces each presenting one of the adjacent opposite magnetic poles. The polar surfaces each have a periphery that is adjacent the periphery of the other polar surface along a polar intersection line. For at least a first one of the polar surfaces, the polar intersection line has a length that is at least one fourth the total length of the periphery of the first polar surface.

In accordance with yet another aspect of the invention there is provided a permanent magnet panel fastener that includes a support member and a multi-pole permanent magnet component attached to the support member, wherein the permanent magnet component includes first and second magnetic regions having respective first and second polar surfaces positioned such that they together present an exposed surface having opposite magnetic poles located adjacent each other. Each of the magnetic regions have a volume and a surface area at the exposed surface, and wherein the ratio of the surface area to the volume for at least one of the magnetic regions is greater than 0.38.

In accordance with another aspect of the invention there is provided a permanent magnet panel fastener that includes a support member and a permanent magnet component. The support member has a first wall that comprises a mounting surface and the permanent magnet component is supported by the mounting surface of the support member and presents an exposed surface having at least one magnetic pole. The permanent magnet component has a volume and a surface area at the exposed surface. The ratio of the surface area to the volume for the permanent magnet component is greater than 0.38.

In accordance with further aspect of the invention there is provided a permanent magnet panel fastener that includes a support member and a multi-pole permanent magnet component, wherein the support member has a first wall that has a thickness and that comprises a mounting surface supporting the multi-pole permanent magnet component. The permanent magnet component includes first and second magnetic regions having respective first and second polar surfaces positioned such that they together present an exposed surface having opposite magnetic poles located adjacent each other. Each of the magnetic regions have a volume and a surface area at the exposed surface such that each of the magnetic regions have a surface area ratio that is equal to the ratio of the surface area to the volume. For at least one of the magnetic regions, the ratio of the surface area ratio to the thickness of the first wall of the support member is greater than 0.27.

In accordance with yet another aspect of the invention there is provided a permanent magnet panel fastener that includes a support member and a permanent magnet component having an exposed surface that has at least one magnetic pole. The support member has a first wall that has a thickness and that comprises a mounting surface supporting the permanent magnet component. The permanent magnet component has a volume and a surface area at the exposed surface such that the magnet component has a surface area ratio that is equal to the ratio of the surface area to the volume. The ratio of the surface area ratio to the thickness of the first wall of the support member is greater than 0.27.

In accordance with another aspect of the invention there is provided a permanent magnet panel fastener that includes a support member and a multi-pole permanent magnet component attached to the support member. The permanent magnet component has an annular shape and first and second polar surfaces positioned such that they together present an exposed surface having opposite magnetic poles located adjacent each other. Each of the first and second polar surfaces are positioned adjacent to each other around the circumference of the annular shaped multi-pole permanent magnet component, and each of the first and second polar surfaces has a periphery defined by inner and outer arcs extending between a pair of radially-extending polar intersection lines.

In accordance with yet another aspect of the invention there is provided a permanent magnet panel fastener that includes a support member and a multi-pole permanent magnet component attached to said support member. The support member has a base wall with an opening in the base wall. The permanent magnet component extends around the opening and has a plurality of polar surfaces positioned about the opening such that they together present an exposed surface having alternating magnetic poles located adjacent each other.

In accordance with a further aspect of the invention there is provided a vehicle panel that includes one or more of the above-defined panel fasteners.

### BRIEF DESCRIPTION OF THE DRAWINGS

Preferred exemplary embodiments of the invention will hereinafter be described in conjunction with the appended drawings, wherein like designations denote like elements, and wherein:

FIG. 1 is a cross-sectional view of a permanent magnet panel fastener constructed in accordance with an embodiment of the invention and showing it securing a panel to a sheet metal substrate;

FIG. 2 is a cross-sectional view of another embodiment of a permanent magnet panel fastener;

FIG. 3 is a cross-sectional view of yet another embodiment of a permanent magnet panel fastener;

FIG. 4 is a cross-sectional view of another embodiment of a permanent magnet panel fastener;

FIG. 5 is a top view of an embodiment of a permanent magnet panel fastener having an annular permanent magnet component;

FIG. 6 is a perspective view of the permanent magnet panel fastener of FIG. 5;

FIG. 7 is a cross-sectional view of another embodiment of a permanent magnet panel fastener having an annular permanent magnet component and showing it securing a panel to a sheet metal substrate;

FIG. 8 is a cross-sectional view of yet another embodiment of a permanent magnet panel fastener having an annular permanent magnet component and showing it securing a panel to a sheet metal substrate;

FIG. 9 is a cross-sectional view (without hatching) of the permanent magnet panel fastener of FIG. 2 with a magnetic field line diagram drawn over the view;

FIG. 10 is a top view of a multi-pole permanent magnet component;

FIG. 11 is a side view of the multi-pole permanent magnet component of FIG. 10;

FIG. 12 is a top view of another embodiment of a multi-pole permanent magnet component;

FIG. 13 is a side view of the multi-pole permanent magnet component of FIG. 12;

FIG. 14 is a top view of an embodiment of an annular permanent magnet component;

FIG. 15 is a cross-sectional view of the annular permanent magnet component of FIG. 14;

FIG. 16 is a top view of another embodiment of an annular permanent magnet component;

FIG. 17 is a cross-sectional view of the annular permanent magnet component of FIG. 16;

FIG. 18 is a top view of yet another embodiment of an annular permanent magnet component; and

FIG. 19 is a cross-sectional view of the annular permanent magnet component of FIG. 18.

### DETAILED DESCRIPTION OF THE ILLUSTRATED EMBODIMENTS

Described herein are various embodiments of a permanent magnet panel fastener that includes a permanent magnet component for attaching a decorative panel to a sheet metal part. As will be apparent from the following disclosure, the shape and magnetization of the permanent magnet component may be configured to help optimize the relationship between its size and holding strength. This may be implemented using a permanent magnet component that includes one or more suitably arranged permanent magnets.

The one or more permanent magnets of the permanent magnet component may be made of any suitably magnetized ferromagnetic material, for example ferrite, alnico, and/or alloys of neodymium, iron and boron. In addition, the one or more permanent magnets may be plated with one or more protective materials, for example zinc, nickel, and/or copper. The sheet metal part may comprise any suitable ferromagnetic material, such as steel, and may be coated with one or more layers of primer and paint.

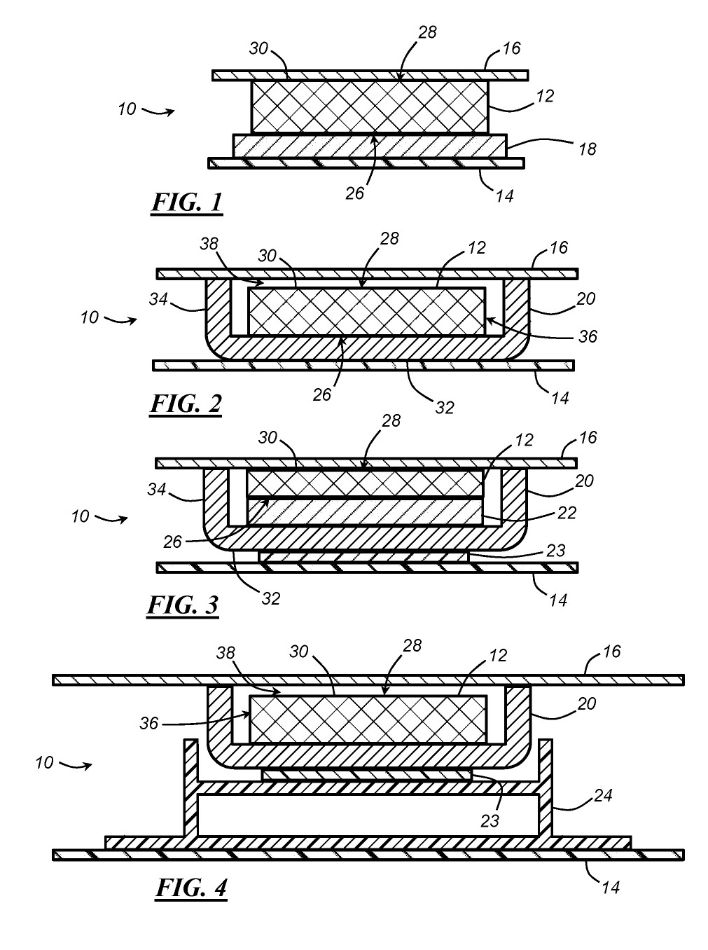

FIG. 1 depicts a cross-sectional view of an embodiment of a permanent magnet panel fastener 10 with a permanent magnet component 12, and shows the fastener 10 securing a panel 14 to a sheet metal part 16. In this embodiment, the permanent magnet component 12 is supported by a flat plate 18 that is attached to the panel 14; however, in other embodiments, the permanent magnet component 12 may be supported by one or more other devices which may or may not be attached to the panel 14.

In one embodiment, as shown in FIG. 2, the permanent magnet component 12 may be supported by a channel-shaped member 20 that is attached to the panel 14. Or, as shown in FIG. 3, the permanent magnet component 12 may be supported by a spacer 22 attached to the channel-shaped member 20, and the channel-shaped member 20 may be further attached to a flexible connector 23 that is attached to the panel 14. In another embodiment, as shown in FIG. 4, the permanent magnet component 12 may be interconnected to a base member 24. In yet another embodiment, the permanent magnet component 12 may be attached to the panel 14 itself, without any intermediate support members or panel attachment features (not shown).

The permanent magnet component 12 may be in the shape of a polygon (e.g., a square, a rectangle, a triangle, etc.), and may include a first side 26 and an opposite second side 28, as shown in FIG. 1. The permanent magnet component 12 may be oriented such that its first side 26 faces towards the panel 14 and its second side 28 faces away from the panel 14. Accordingly, the second side 28 of the permanent magnet component 12 has an exposed surface 30 on its second side 28 which may be placed near the sheet metal part 16 to attach or secure the sheet metal part 16 to the panel 14. If one or more of the support or attachment members in FIGS. 1-4 is made of a ferromagnetic material, the first side 26 of the permanent magnet component 12 will be magnetically shielded by the ferromagnetic member or members, but its second side 28 will not.

As shown in FIG. 2, the channel-shaped member 20 has a first wall 32 and one or more sidewalls 34 which extend away from the first wall 32. Each sidewall 34 of the channel-shaped member 20 extends from a proximal end located at the first wall 32 to a distal end spaced apart from the first wall 32. Together, the first wall 32 and the one or more sidewalls 34 at least partially define a magnet receiving space 36 of the channel-shaped member 20 for receiving the permanent magnet component 12 therein. The magnet receiving space 36 of the channel-shaped member 20 includes a closed end at the first wall 32 and an open end proximate to the distal ends of the one or more sidewalls 34. Accordingly, when the permanent magnet component 12 is in the magnet receiving space 36 of the channel-shaped member 20, the exposed surface 30 on the second side 28 of the permanent magnet component 12 will correspond to the open end of the magnet receiving space 36.

The permanent magnet component 12 may be positioned within the magnet receiving space 36 such that an air gap 38 exists between the sheet metal part 16 and the second side 28 of the permanent magnet component 12, as shown in FIG. 2. In one embodiment, the air gap 38 may have a thickness of 0.13 mm or less. In another embodiment, as shown in FIG. 3, the second side 28 of the permanent magnet component 12 may be flush with the vertical extent of the distal ends of the sidewall(s) 34 such that the magnet component 12 engages the sheet metal part 16, and the spacer 22 may be used to adjust or eliminate the air gap 38.

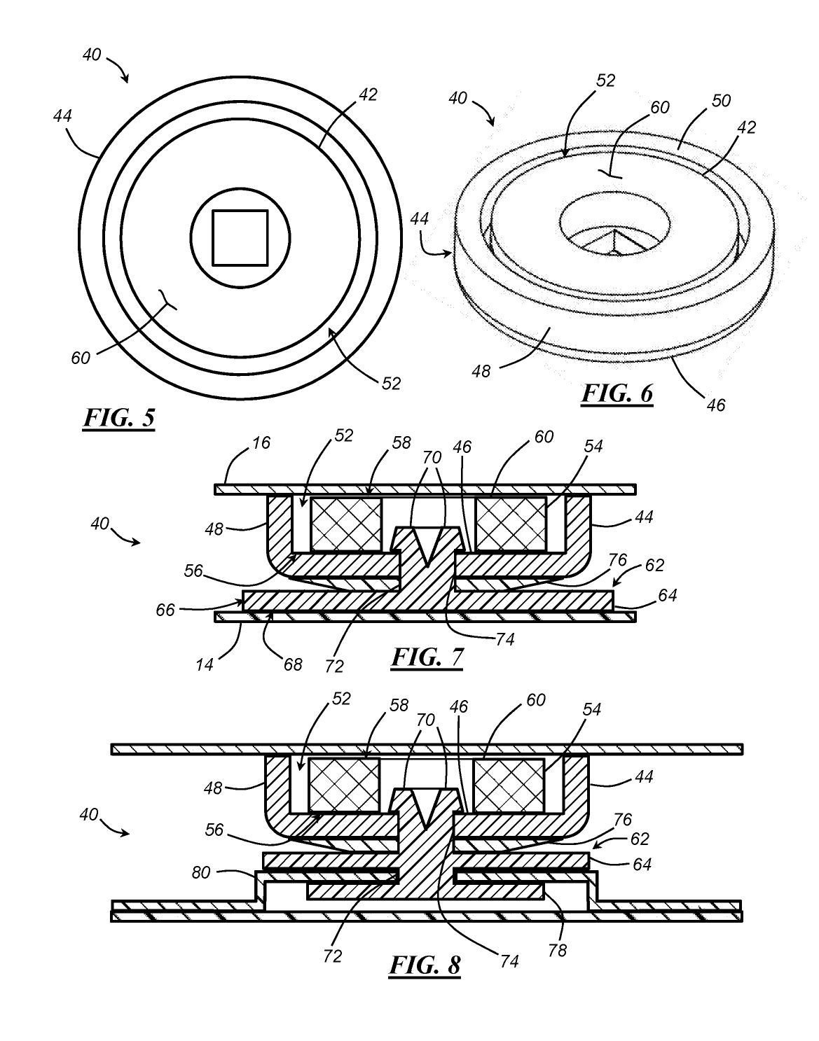

In another embodiment, as shown in FIGS. 5-8, a permanent magnet panel fastener 40 with an annular permanent magnet component 42 may be used to secure the panel 14 to the sheet metal part 16. The annular permanent magnet component 42 may be supported by a cup-shaped member 44 with a base wall 46 and a circular sidewall 48 extending from the base wall 46 to a rim 50. Together, the base wall 46 and the circular sidewall 48 define a cylindrical magnet receiving space 52 for the annular permanent magnet component 42.

The annular permanent magnet component 54 shown in FIGS. 7 and 8 has a first side 56 and an opposite, second side 58. When the annular permanent magnet component 54 is positioned inside the cylindrical magnet receiving space 52, its first side 56 faces the base wall 46 and its second side faces away from the base wall 46. If the cup-shaped member 44 is made of a ferromagnetic material, the first side 56 of the permanent magnet component 54 will be magnetically shielded, but its second side 58 will not. In such case, the second side 58 of the permanent magnet component 54 will have an exposed surface 60 which may be placed near the sheet metal part 16 to attach or secure the sheet metal part 16 to the panel 14.

As shown in FIG. 7, a clip fastener 62 may be used to attach the cup-shaped member 44 and the annular permanent magnet component 54 to the panel 14. The clip fastener 62 shown in FIG. 7 includes a disk-shaped body portion 64 having first and second opposite surfaces 66, 68 and a pair of legs 70 connected to the body portion 64 at the first surface 66 via a central hub 72. During assembly, the legs 70 of the clip fastener 62 pass through an opening 74 in the base wall 46 and positively engage the clip fastener 68. In some embodiments, an annular spacer 76 (e.g., a cup or convex washer) may be positioned between the base wall 46 of the cup-shaped member 44 and the body portion 64 of the clip fastener 62 to allow for movement or articulation of the cup-shaped member 44 relative to the panel 14.

The clip fastener 62 may be attached to the panel 14 via any suitable mechanical connection. For example, as indicated in FIG. 7, the body portion 64 of the clip fastener 62 may be directly attached to the panel 14. In other embodiments, the clip fastener 62 may include additional features such as a lower flange 78 that enables the clip fastener 62 to be inserted through an enlarged aperture on a raised panel extension 80 such as shown in FIG. 8, and then slid laterally into a narrower portion of the aperture to capture the central hub 72. Other suitable attachment arrangements will become apparent to those skilled in the art.

In its fully assembled position, the permanent magnet component of the permanent magnet panel fastener is oriented such that its first side faces towards the panel and its second side faces away from the panel, towards the sheet metal part. In addition, the permanent magnet component is oriented such that its first and second sides correspond to its magnetic poles, with the permanent magnet component presenting at least one magnetic pole at its exposed surface on its second side.

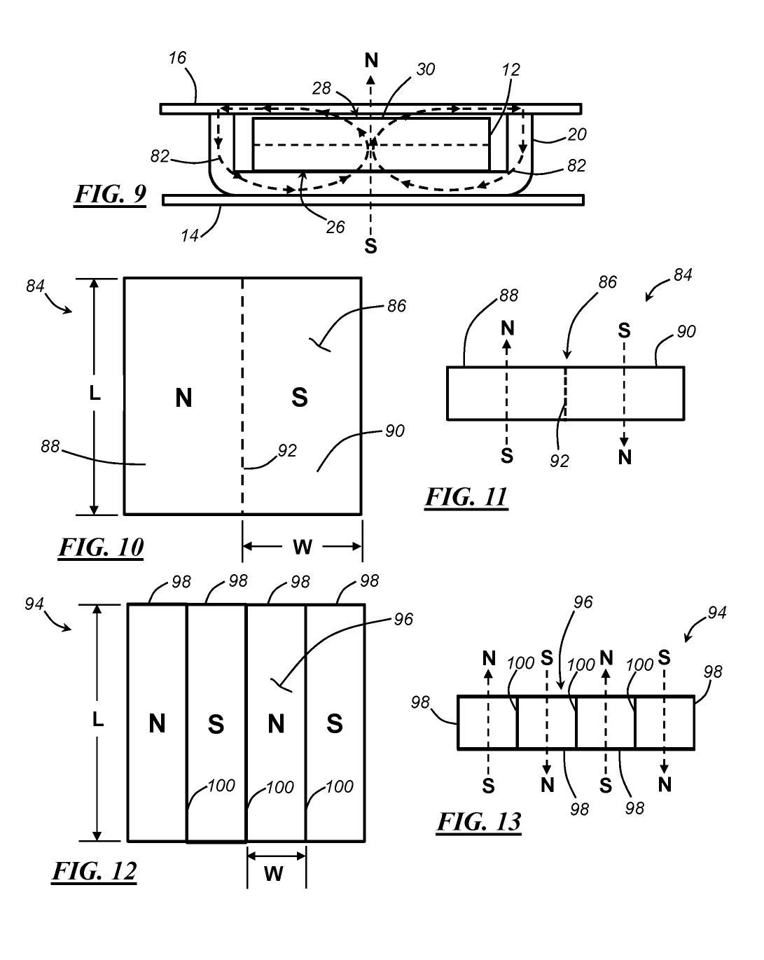

FIG. 9 is a cross-sectional view of the permanent magnet component 12 of FIG. 2 and is shown without hatching to better illustrate the magnetic poles and the magnetic flux generated by the permanent magnet component 12. A magnetic field line diagram, including two illustrative magnetic flux lines 82, has been drawn over the permanent magnet component 12 to illustrate one exemplary magnetic flux path generated by the permanent magnet component 12. In this embodiment, the permanent magnet component 12 presents a north pole N at its exposed surface 30, on its second side 28, and presents a corresponding south pole S at its opposite first side 26 which is shielded from the surrounding space by the channel-shaped member 20. In this arrangement, the sheet metal part 16 may be brought towards the exposed surface 30, wherein the permanent magnet component 12 will exert a magnetic force on the sheet metal part 16 and fasten or attach it to the panel 14.

In accordance with the teachings herein, the permanent magnet component may be designed such that it does not saturate or at least does not significantly over-saturate the sheet metal part. Thus, for example, although only two flux lines are shown in FIG. 9, it will be appreciated by those skilled in the art that, by suitable configuration of the permanent magnet component, all or substantially all of the flux produced by the permanent magnet component will be carried by the sheet metal part. In such case, the proximal portion of sheet metal part may be taken to, near, or just over full magnetic saturation.

As compared to prior art permanent magnet panel fasteners, the permanent magnet panel fastener of the present invention provides the benefit of achieving a near maximal holding force for the particular dimensions of the fastener, while avoiding wasted magnetic flux by over-saturating the sheet metal part, for example, by using a magnet that is stronger and, thus, more massive and expensive than is otherwise necessary. Suitably, the permanent magnet panel fastener may be used to attach a panel to a sheet metal part having a thickness in the range of 0.5 mm to 1.7 mm. The magnetization, dimensional and volumetric relationships, and other construction features of the permanent magnet component will be discussed below that help enable this efficient magnetic holding capability of the permanent magnet panel fastener.

The maximum holding force of four commercially-available permanent magnet panel fasteners having permanent magnet components with different volumes was measured on three conventional sheet metal body panels with different thicknesses. As shown in Table 1 below, the maximum holding force of each prior art fastener increases as the thickness of the sheet metal body panel increases. These results indicate that the permanent magnet components of these prior art fasteners are stronger than necessary, and tend to over-saturate conventional sheet metal body panels.

TABLE 1

| | Maximum Holding Force (lbs.) | | |
|---|---|---|---|
| Permanent | 0.7 mm sheet metal | 0.8 mm sheet | 1.5 mm sheet |
| Magnet | panel with E-coat and | metal panel with | metal panel with |
| Volume (mm³) | Paint | E-coat | E-coat |
| 367 | 9.4 | 11.6 | 20.2 |
| 405 | 8.5 | 10.3 | 13 |
| 532 | 14.5 | 16 | 27 |
| 551 | 12 | 15 | 26 |

The maximum holding force of three bi-pole magnets was measured to determine the optimal volume bi-pole magnet for a conventional 0.7 mm sheet metal body panel (with E-coat and paint), and the results are shown in Table 2 below. When the volume of a commercially-available bi-pole magnet was reduced from 1152 mm³ to 576 mm³ while maintaining the exposed (polar) surface area of the magnet constant, the maximum holding force decreased from 13.5 lbs. to 12.5 lbs. Even though the volume of the bi-pole magnet was cut in half, the holding force only decreased by 7.4%, which suggests that a 1152 mm³ magnet is more massive and expensive than is otherwise necessary for a 0.7 mm sheet metal body panel. But, when the volume of the bi-pole magnet was further reduced from 576 mm³ to 288 mm³ while maintaining other dimensions constant, the maximum holding force decreased from 12.5 lbs. to 9 lbs, a 28% reduction in holding force, which suggests that a 288 mm³ magnet may not fully saturate a 0.7 mm sheet metal body panel.

TABLE 2

| Permanent Magnet | Type of | Max. Holding |
|---|---|---|
| Volume (mm³) | Support | Force (lbs.) |
| 288 | Flat Plate | 9 |
| 512 | Channel | 15 |
| 576 | Flat Plate | 12.5 |
| 1152 | Flat Plate | 13.5 |

The size and shape of the permanent magnet component may be configured to achieving a near maximal holding force for the particular dimensions of the fastener and sheet metal part. From the dimensions of the permanent magnet component, the volume (V) and the surface area (SA) at an exposed surface of the permanent magnet component may be calculated. In accordance with at least some embodiments, the permanent magnet component may have a thickness in the range of 1/32 inch to ¼ inch, and a length, width, and/or diameter in the range of 1/16 to 3 inches in some embodiments, ½ inch to 2 inches in other embodiments. In addition, the volume of the permanent magnet component may be in the range of 100 to 1500 cubic millimeters, and the surface area at the exposed surface of the permanent magnet component may be in the range of 100 to 500 square millimeters. Suitable other thicknesses, volumes, and surface areas outside of these ranges are also possible depending upon the particular fastener application.

The ratio of the surface area of the exposed surface of the permanent magnet component to the volume of the permanent magnet component may be controlled to help optimize the relationship between the holding strength and size of the magnet component; this ratio may be referred to herein as the SA/V ratio. Suitably, the shape of each permanent magnet component is configured so that the permanent magnet component has an SA/V ratio greater than 0.38. In one embodiment, the SA/V ratio of the permanent magnet component is greater than 0.4. In another embodiment, the SA/V ratio of the permanent magnet component is greater than 0.6.

When the permanent magnet component is supported by a support member, the shape of the support member may vary depending upon the intended use of the permanent magnet panel fastener. However, each support member will have a mounting surface that supports the permanent magnet component, and the wall or side of the permanent magnet component that corresponds to this surface (i.e., the support wall) will have a given thickness (Tₛᵤₚₚₒᵣₜ, or just Tₛ), which may be in the range of ½ to 2.5 millimeters, preferably for some embodiments between one to two millimeters.

The ratio between the SA/V ratio of the permanent magnet component and the thickness of the support wall may be referred to as the (SA/V)/Tₛ ratio. Suitably, the shape of the permanent magnet component and the thickness of the support wall are configured to yield an (SA/V)/Tₛ ratio greater than 0.27. In one embodiment, the (SA/V)/Tₛ ratio is greater than 0.3. In another embodiment, the (SA/V)/Tₛ ratio is greater than 0.4. Some of these embodiments involving one or more of the SA/V ratios and/or one or more of the (SA/V)/Tₛ ratios may be made using a suitably magnetized single bi-pole permanent magnet component, whereas others may use a permanent magnet component consisting of more than one bi-pole magnet.

As discussed above, the permanent magnet component of the present invention presents at least one magnetic pole at its exposed surface on its second side. In some embodiments; however, the permanent magnet component may present at least two adjacent opposite magnetic poles at its exposed surface on its second side. In these embodiments, the permanent magnet component may be referred to as a multi-pole permanent magnet component. FIGS. 9-13 and 16-19 depict embodiments of a permanent magnet component which presents at least two adjacent opposite magnetic poles at its exposed surface.

FIGS. 10 and 11 depict a top view and a side view, respectively, of one exemplary configuration of a multi-pole permanent magnet component 84 having two adjacent opposite magnet poles at its exposed surface 86. In this embodiment, the exposed surface 86 of the multi-pole permanent magnet component 84 has a first polar surface 88 which presents one magnetic pole (e.g., north), and a second polar surface 90 which presents an opposite magnetic pole (e.g., south). These two polar surfaces 88, 90 confront each other along a rectilinear or curved line that comprises the polar intersection of the surfaces 88, 90. This is shown as a dashed line 92 on the top and side view of the multi-pole permanent magnet component 84. As such, this line of polar intersection of two adjacent (confronting) opposite magnetic poles on the surface of the magnet component is referred to herein as a “polar intersection line.” This line may be at a physical juncture between the two poles or at an intermediate space between the peripheries of the polar surfaces in the event that they are separated by some distance which, in some embodiments, may be a few millimeters or less.

The multi-pole permanent magnet component 84 depicted in FIGS. 10 and 11 is a unitary permanent magnet having regions of opposite magnetic domains that provide the two opposite magnetic poles at its exposed surface 86. However, the adjacent opposite poles on the exposed surface of a multi-pole permanent magnet component may suitably be formed by a composite of two bi-pole magnets mechanically secured side-by-side in any suitable manner.

FIGS. 12 and 13 depict a top view and a side view, respectively, of another exemplary configuration of a multi-pole permanent magnet component 94 having four adjacent opposite magnet poles at its exposed surface 96. In this embodiment, four bi-pole magnets 98 are positioned adjacent to each other such that they together present four adjacent opposite magnet poles, corresponding to four polar surfaces, at the exposed surface 96 of the multi-pole permanent magnet component 94. The four bi-pole magnets 98 are positioned adjacent to each other and form three polar intersection lines 100 along the abutting portions of their peripheries. The bi-pole magnets 98 may be attached to each other, or may be separately mounted and not directly attached to each other. The polar intersection lines 100 shown in FIGS. 12 and 13 are shown as solid lines to better illustrate the physically separate nature of the bi-pole magnets 98.

In embodiments where the multi-pole permanent magnet component consists of more than one bi-pole magnet, the bi-pole magnets may be suitably positioned adjacent to each other; however, the bi-pole magnets do not need to be in direct contact. For example, the bi-pole magnets may be spaced apart from each other at a distance of up to about 2 to 3 millimeters, or for other embodiments could be greater than this range.

The polar surfaces shown in FIGS. 10-13 are rectangular in shape; however, in other embodiments, the polar surfaces may have different shapes. For example, the polar surfaces may be in the shape of any suitable polygon (e.g., a square, a rectangle, a triangle, etc.), and the polar intersection line(s) formed between the adjacent opposite poles may be rectilinear. In another example, the polar surfaces may have curved peripheries, and said polar intersection line(s) may be curved.

In FIGS. 10-13, each rectangular polar surface has a length L and a width W. In these embodiments, the width W of each individual polar surface is suitably less than or equal to the length L of the polar surface, and the polar surfaces are preferably positioned adjacent to each other along their lengths L, as shown. In other words, the length L of the polar intersection line preferably comprises at least 25% of the total periphery of each polar surface. In other embodiments, the polar surfaces of each multi-pole permanent magnet component are suitably positioned adjacent to each other such that the polar intersection line of any two adjacent opposite magnetic poles is long enough that a significant amount of the flux lines from the opposite poles are tightly coupled at the polar intersection line. For example, the polar intersection line of any two adjacent polar surfaces may also correspond to the longest side of the polar surfaces.

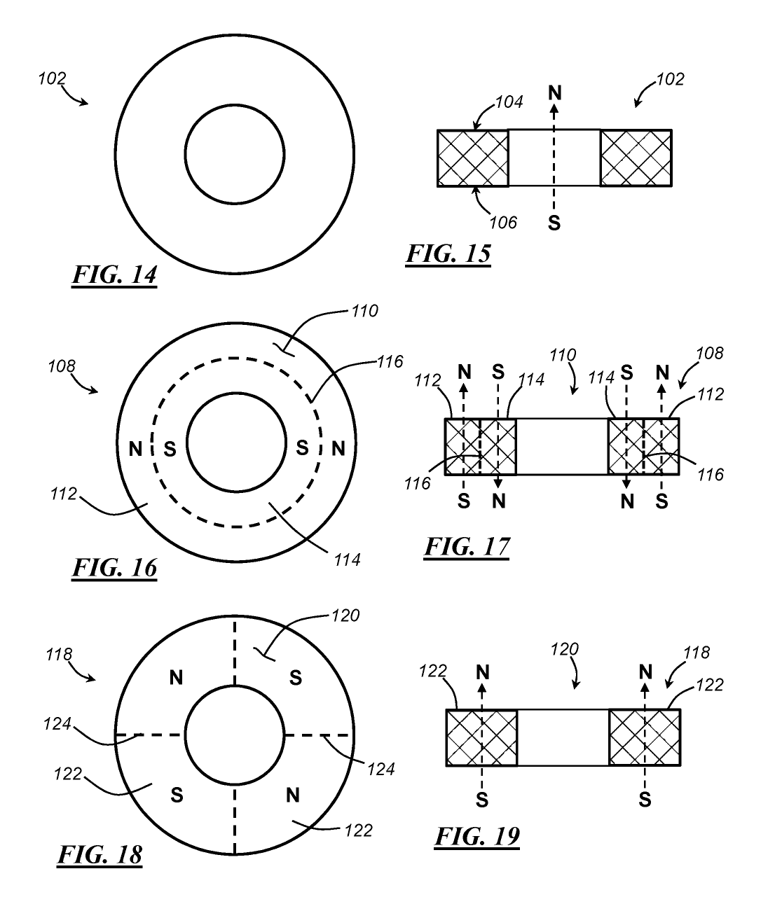

FIGS. 14 and 15 depict a top view and a cross-sectional view, respectively, of one embodiment of an annular permanent magnet component 102. When assembled, the annular permanent magnet component 102 may be oriented so that either its first side 104 or its opposite, second side 106 is proximal to the sheet metal part. In this embodiment, the annular permanent magnet component 102 presents a north pole N on its first side 104, and a corresponding south pole S on its second side 106. Each of the first and second sides 104, 106 includes one polar surface in the shape of a ring.

FIGS. 16 and 17 depict a top view and a cross-sectional view, respectively, of one exemplary configuration of a multi-pole annular permanent magnet component 108 presenting two adjacent opposite magnet poles at its exposed surface 110. In this embodiment, the exposed surface 110 of the annular multi-pole permanent magnet component 108 has a first polar surface 114 which presents one magnetic pole (e.g., north), and a second polar surface 112 which presents an opposite magnetic pole (e.g., south). These polar surfaces comprise concentric shapes with the periphery of the first polar surface 114 comprising an outer periphery and the periphery of the second polar surface 112 comprising an inner periphery. The respective inner and outer peripheries of these polar surfaces 114, 112 are adjacent each other, with their polar intersection 116 being circular and extending circumferentially around the periphery of the first polar surface 114.

FIGS. 18 and 19 depict a top view and a cross-sectional view, respectively, of another exemplary configuration of an annular multi-pole permanent magnet component 118 having four adjacent opposite magnet poles at its exposed surface 120. In this embodiment, the polar surfaces 122 are positioned adjacent to each other at different points around the circumference of the annular multi-pole permanent magnet component 118. The polar intersection lines 124 of these polar surfaces 122 are shown by radially-extending dashed lines. Each polar surface 122 has a periphery defined by inner and outer arcs extending between a pair of adjacent radially-extending polar intersection lines 124.

The maximum holding force of several permanent magnet panel fasteners having multi-pole permanent magnet components was measured to illustrate the advantages of positioning the polar surfaces of such magnets adjacent to each other along their lengths L, instead of along their widths W, and the results of these measurements are shown in Table 3 below. Table 3 includes measurements taken using a sheet metal body panel with a thickness of 0.8 mm and coated with E-coat.

TABLE 3

| | # of Bi- | Position | Total Magnet | | Max. |
|---|---|---|---|---|---|
| Fastener | Pole | (along L | Volume | Type of | Holding |
| # | Magnets | or W) | (mm³) | Support | Force (lbs.) |
| 1 | 1 | N/A | 288 | Flat Plate | 8 |
| 2 | 3 | L | 288 | Flat Plate | 15 |
| 3 | 4 | W | 384 | Flat Plate | 15 |
| 4 | 4 | L | 384 | Flat Plate | 22 |

Fastener #3 is a known fastener that includes a flat plate support member and 4 rectangular bi-pole magnets (with widths W shorter than their lengths L) positioned adjacent to each other along their widths. Fastener #4 was constructed in accordance with the teachings herein and includes a flat plate support member and 4 rectangular bi-pole magnets (with widths W shorter than their lengths L) positioned adjacent to each other along their lengths. As shown, Fastener #3 exhibited a maximum holding force of 15 lbs., while Fastener #4 exhibited a maximum holding force of 22 lbs., which illustrates how positioning the polar surfaces of multi-pole permanent magnet components adjacent to each other along their lengths L, instead of along their widths W, can increase the strength of the overall permanent magnet component.

The above measurements also illustrate the advantages of incorporating multi-pole permanent magnet components into panel fasteners. As indicated for the known Fastener #1, the maximum holding force of a commercially-available permanent magnet panel fastener having a flat plate support member and a single bi-pole magnet with a volume of 288 mm³ was found to be 8 lbs. For comparison, the maximum holding force was measured for Fastener #2 which was constructed in accordance with the teachings herein and which also includes a flat plate support member and a permanent magnet component with a volume of 288 mm³. As shown in Table 3, the permanent magnet component of Fastener #2 includes 3 rectangular bi-pole magnets (with widths W shorter than their lengths L) positioned adjacent to each other along their lengths, and exhibits a maximum holding force of 15 lbs. on the same sheet metal body panel. Therefore, using a multi-pole permanent magnet component, instead of a single bi-pole magnet of the same volume, can significantly increase the holding force of a fastener.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

What is claimed is:

1. A permanent magnet panel fastener for attaching a panel to a metal part, comprising:
a support member having a first wall and a sidewall, the sidewall includes a proximal end and a distal end, the proximal end extends from the first wall, the distal end is located at an opposite end of the sidewall from the proximate end and is arranged to face the metal part when installed, and the first wall and the sidewall define a magnet receiving space;
a multi-pole permanent magnet component having a plurality of magnetic regions, a first side and a second side, the plurality of magnetic regions have a plurality of polar surfaces where each polar surface has a magnetic pole, the first side faces the support member and the second side is arranged to face the metal part when installed, the second side is opposite the first side through the thickness of the multi-pole permanent magnet, the second side includes the plurality of polar surfaces, and the plurality of polar surfaces are arranged on the second side such that at least two polar surfaces have opposite magnetic poles; and
a panel attachment feature connected to the support member, the panel attachment feature is arranged to attach the permanent magnet panel fastener to the panel when installed;
wherein the multi-pole permanent magnet component is located within the magnet receiving space and is arranged such that the second side with the plurality of polar surfaces and the distal end are flush with one another and will contact the metal part when the permanent magnet panel fastener is installed.

2. The permanent magnet panel fastener of claim 1, wherein the support member includes a channel-shaped member or a cup-shaped member.

3. The permanent magnet panel fastener of claim 1, wherein the support member is ferromagnetic so that the multi-pole permanent magnet component is retained within the magnet receiving space by magnetic attraction.

4. The permanent magnet panel fastener of claim 1, wherein the at least two polar surfaces that have opposite magnetic poles are separated by at least one polar intersecting line, and the at least one polar intersecting line has a length that is at least one fourth of a total length of a periphery of each of the adjacent polar surfaces.

5. The permanent magnet panel fastener of claim 1, wherein the multi-pole permanent magnet component is arranged such that when the permanent magnet panel fastener is installed and the second side contacts the metal part at a location having a thickness in the range of 0.5 mm to about 1.7 mm, the multi-pole permanent magnet component will generate a magnetic field that fastens the permanent magnet panel fastener to the metal part without saturating the metal part.

6. The permanent magnet panel fastener of claim 1, wherein the multi-pole permanent magnet component further has a first magnetic region and a second magnetic region, the first magnetic region is annular in shape and has a first polar surface with a first magnetic pole, the second magnetic region is annular in shape and has a second polar surface with a second magnetic pole that is opposite the first magnetic pole, the first and second magnetic regions are concentric with the first magnetic region located radially inward of the second magnetic region, and the first and second magnetic regions are separated by at least one annular polar intersecting line.

7. The permanent magnet panel fastener of claim 1, wherein the multi-pole permanent magnet component further has a first magnetic region and a second magnetic region, the first magnetic region is polygonal in shape and has a first polar surface with a first magnetic pole, the second magnetic region is polygonal in shape and has a second polar surface with a second magnetic pole that is opposite the first magnetic pole, the first and second magnetic regions are adjacent, and the first and second magnetic regions are separated by at least one rectilinear polar intersecting line.

8. The permanent magnet panel fastener of claim 1, wherein the multi-pole permanent magnet component includes a unitary magnetic component that has the plurality of magnetic regions.

9. The permanent magnet panel fastener of claim 1, wherein the multi-pole permanent magnet component includes a plurality of separate bi-pole magnets that have the plurality of magnetic regions

10. A vehicle panel having the permanent magnet panel fastener of claim 1 attached to the vehicle panel.

11. A permanent magnet panel fastener for attaching a panel to a metal part, comprising:
a support member having a first wall, and the first wall at least partially defines a magnet receiving space; and
a multi-pole permanent magnet component having a plurality of magnetic regions, a first side and a second side, the plurality of magnetic regions have a plurality of polar surfaces where each polar surface has a magnetic pole and a perimeter, the first side faces the support member and the second side is arranged to face the metal part when installed, the second side is opposite the first side through the thickness of the multi-pole permanent magnet, the second side includes the plurality of polar surfaces, the plurality of polar surfaces are arranged on the second side such that adjacent polar surfaces have opposite magnetic poles and are separated by at least one polar intersecting line, and the at least one polar intersecting line has a length that is at least one fourth of a total length of a periphery of each of the adjacent polar surfaces;
wherein the multi-pole permanent magnet component is located within the magnet receiving space and is arranged such that when the permanent magnet panel fastener is installed and the second side contacts the metal part at a location having a thickness in the range of 0.5 mm to about 1.7 mm, the multi-pole permanent magnet component will generate a magnetic field that fastens the permanent magnet panel fastener to the metal part without saturating the metal part.

12. The permanent magnet panel fastener of claim 11, wherein the support member further has a sidewall, the sidewall includes a proximal end and a distal end, the proximal end extends from the first wall, the distal end is located at an opposite end of the sidewall from the proximate end and is arranged to face the metal part when installed, and the first wall and the sidewall define the magnet receiving space, wherein the multi-pole permanent magnet component is located within the magnet receiving space and is arranged such that the second side with the plurality of polar surfaces and the distal end are flush with one another and will contact the metal part when the permanent magnet panel fastener is installed.

13. The permanent magnet panel fastener of claim 12, wherein the support member includes a channel-shaped member or a cup-shaped member.

14. The permanent magnet panel fastener of claim 11, wherein the support member is ferromagnetic so that the multi-pole permanent magnet component is retained within the magnet receiving space by magnetic attraction.

15. The permanent magnet panel fastener of claim 11, wherein the multi-pole permanent magnet component further has a first magnetic region and a second magnetic region, the first magnetic region is annular in shape and has a first polar surface with a first magnetic pole, the second magnetic region is annular in shape and has a second polar surface with a second magnetic pole that is opposite the first magnetic pole, the first and second magnetic regions are concentric with the first magnetic region located radially inward of the second magnetic region, and the first and second magnetic regions are separated by at least one annular polar intersecting line.

16. The permanent magnet panel fastener of claim 11, wherein the multi-pole permanent magnet component further has a first magnetic region and a second magnetic region, the first magnetic region is polygonal in shape and has a first polar surface with a first magnetic pole, the second magnetic region is polygonal in shape and has a second polar surface with a second magnetic pole that is opposite the first magnetic pole, the first and second magnetic regions are adjacent, and the first and second magnetic regions are separated by at least one rectilinear polar intersecting line.

17. The permanent magnet panel fastener of claim 11, wherein the multi-pole permanent magnet component includes a unitary magnetic component that has the plurality of magnetic regions.

18. The permanent magnet panel fastener of claim 11, wherein the multi-pole permanent magnet component includes a plurality of separate bi-pole magnets that have the plurality of magnetic regions

19. A vehicle panel having the permanent magnet panel fastener of claim 11 attached to the vehicle panel.

20. A permanent magnet panel fastener for attaching a panel to a metal part, comprising:
a support member having a first wall, and the first wall at least partially defines a magnet receiving space that is circular in shape; and
a multi-pole permanent magnet component having a first magnetic region,
a second magnetic region, a first side and a second side, the first magnetic region is annular in shape and has a first polar surface with a first magnetic pole, the second magnetic region is annular in shape and has a second polar surface with a second magnetic pole that is opposite the first magnetic pole, the first magnetic region is located radially inward of the second magnetic region and is separated from the second magnetic region by at least one annular polar intersecting line, the first side faces the support member and the second side is arranged to face the metal part when installed, the second side is opposite the first side through the thickness of the multi-pole permanent magnet, and the second side includes the first and second polar surfaces;
wherein the multi-pole permanent magnet component is located within the magnet receiving space and is arranged such that when the permanent magnet panel fastener is installed onto the metal part, the multi-pole permanent magnet component will generate a magnetic field that fastens the permanent magnet panel fastener to the metal part.
